(19) United States
(12) Patent Application Publication
(10) Pub. No.: US 2011/0285629 A1
(43) Pub. Date: Nov. 24, 2011

(54) Computer Mouse, In Particular a Laser Mouse

(76) Inventor: Nunzio La Vecchia, Ascona (CH)

(21) Appl. No.: 13/144,317

(22) PCT Filed: Oct. 22, 2009
(86) PCT No.: PCT/EP2009/007561

§ 371 Date: Aug. 10, 2011

(30) Foreign Application Priority Data
Jan. 15, 2009 (EP) 09405009.3

(51) Int. Cl. G06F 3/033

(52) U.S. Cl. 345/163

(57) ABSTRACT

The invention relates to a computer mouse, in particular a laser mouse, wherein the housing (2) is formed as a miniaturized automobile model, the front hood (5) thereof having a plurality of actuating elements. At least one mass storage device (21) for storing data and at least one interface, preferably a USB connection (20) for connecting the mass storage device (21) to a computer or the like, are additionally integrated in the housing (20). The housing (2) of the automobile model comprises a front hood (5) divided into at least two parts and two buttons (5a, 5b) are formed thereby. In said computer mouse, existing automobile models are copied to scale, thereby resulting in a very special esthetic mouse for a user that can also be used for storing data as an additional function.

The invention relates to a computer mouse, in particular a laser mouse according to the preamble to Claim 1.

Computer mice of this type are generally known and available on the market in a wide variety of configurations.

The object forming the basis of the present invention is to provide a computer mouse which, in comparison to the conventional computer mice, offers an extended function, and with which a special shape is also made possible.

This object is achieved according to the invention by a computer mouse having the features of Claim 1.

With this computer mouse according to the invention existing car models are reproduced to scale, and so a user is provided with a very special, aesthetic mouse at his work place. This type of computer mouse is also particularly suitable for advertising purposes.

With the integrated permanent storage device and the corresponding USB connection or similar, the latter can be used for safeguarding data as an additional function.

Further preferred configurations of the invention form the subject matter of the dependent claims. Thus, by forming turning wheels easier movement of the mouse is achieved.

In the following the invention is described in more detail by means of the drawings. These show as follows:

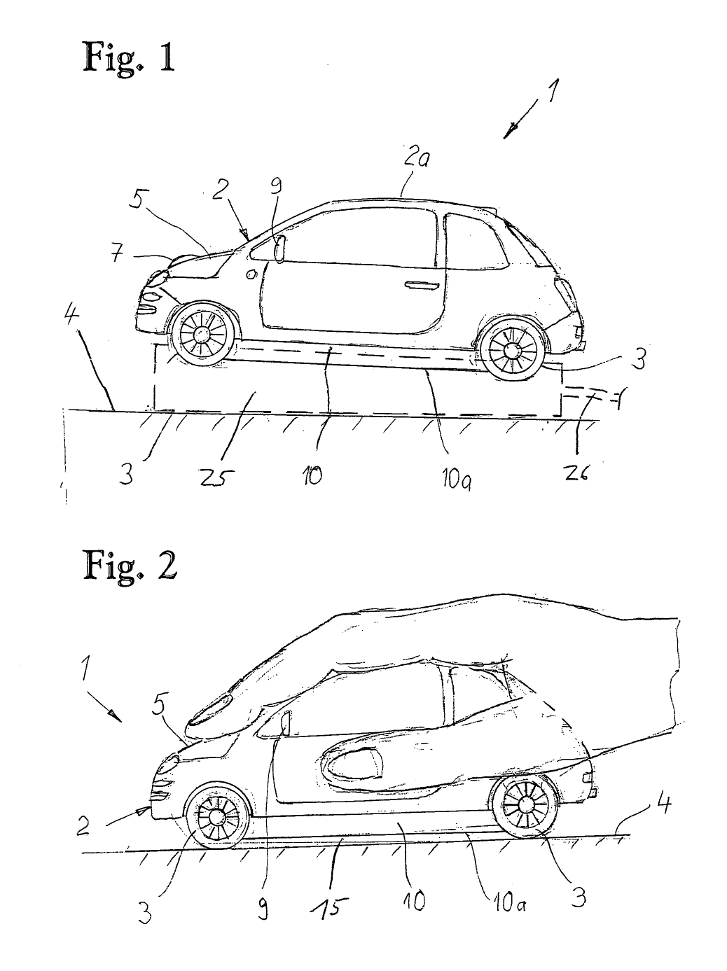

FIG. 1 is a side view of an exemplary embodiment of a computer mouse according to the invention;

FIG. 2 is the side view of the computer mouse according to FIG. 1 during use;

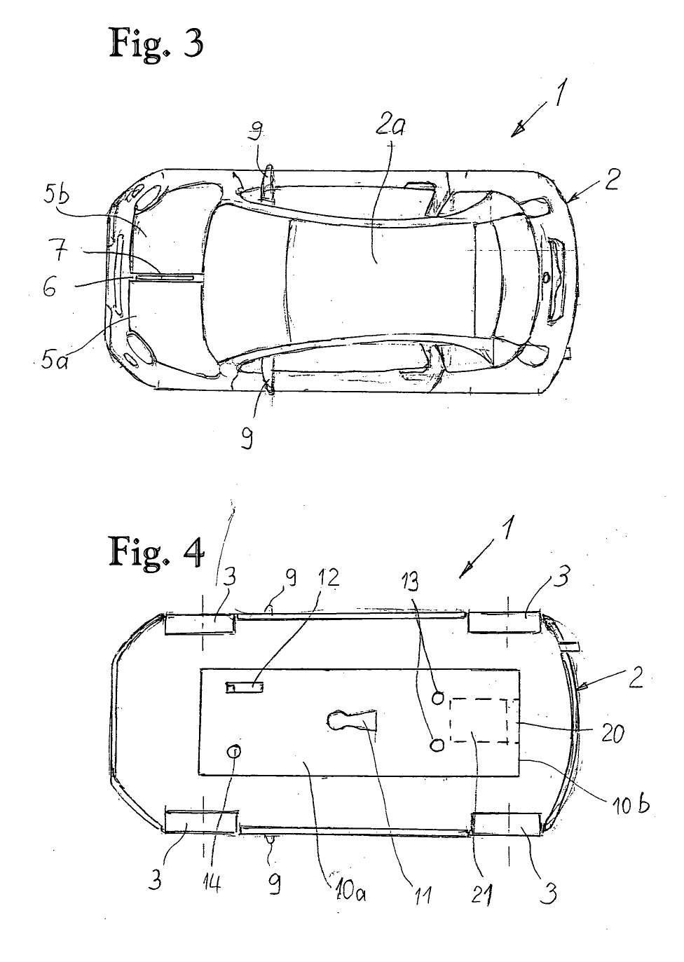

FIG. 3 is a top view of the computer mouse according to FIG. 1; and

FIG. 4 is a view from beneath this computer mouse according to FIG. 1.

In FIG. 1 to FIG. 4 a computer mouse 1 is illustrated which as such works like a conventional mouse, and correspondingly, when not being used, can be plugged onto a charging station 25 connectable to the computer or similar via a USB cable 26, and can be charged in this integrated accumulator by means of a plug or contact connection (not detailed). The way in which the computer mouse 1 communicates with the computer is known in its own right—either via a cable connection or, as shown, without a cable (wireless) via a radio connection to the charging station 25 in the form of a receiver. This is therefore preferably an optical mouse, in particular a laser mouse, the sensor system of which includes laser diodes. The structure and the mode of operation of a laser mouse is likewise known in its own right, and so will not be described in any more detail.

According to the invention this computer mouse 1 is in the form of a miniaturised model of a car, preferably of an existing make of car, which comprises a housing 2 and wheels 3, it being possible to place the wheels 3 on a work surface 4. The upper side of the mouse serves as a support 2a for the palm of the hand, as can be seen in FIG. 2.

According to the invention according to FIG. 3, the front hood 5 of the car model is divided into two parts 5a, 5b which form two moveable button surfaces of the computer mouse 1 (the left and the right button) which can each be operated by a finger tip. Between the parts 5a, 5b there is a slot 6 from which a scroll and/or mouse wheel 7 projects upwardly. By turning the wheel 7 scrolling functions, for example, can be executed, but the same can also be configured as a button operated by pressing.

According to the invention there is integrated into the housing 2 of the computer mouse 1 a USB connection 20 (or another interface) with a mass storage device 21 for storing data so that the computer mouse 1 can also take on the function of a memory stick in addition to the classical function. The USB connection 20 serving as an interface is advantageously fitted to the side on the outer circumference 10b of the base 10, preferably in the rear region of the car model, it being possible to connect it to the computer by means of a cable.

The computer mouse 1 can additionally be equipped with further operable actuating elements for additional functions, which can be assigned to individual components of the car model forming the housing 2, for example the external mirrors 9.

The housing 2 has a lower base 10, the lower side 10a of which is provided with a light hole 11, an on and off switch 12, charging openings 13 and a connection button 14 (see FIG. 4).

As can be seen from FIGS. 1 and 2, with a car model standing on the work surface 4 with its wheels 3, there is between the work surface 4 and the lower side 10a of the base 10 a gap 15.

The wheels 3 of the car model can be formed such that they can turn and, in addition, when the computer mouse is moved they can be steered, the outer circumference of the base 10 allowing the wheels 3 to swivel out from a straight direction. The front wheels 3 can be steered, for example, by means of a wheel arranged similarly to the wheel 7 for the mouse function.

Within the framework of the invention provision can be made such that when the mouse 1 is switched on by means of an on and off switch 12, an engine noise can be heard, in particular when moving the mouse, car lights can be switched on, and/or a car horn can be sounded.

The invention is sufficiently presented by the exemplary embodiment described in more detail above. It could of course also be realised by further variants. Thus, instead of an accumulator, just an exchangeable battery could also be contained in the housing, or as an environmentally friendly solution it is conceivable to fit solar cells to the housing and to provide these for charging the accumulator.

1. A computer mouse, in particular a laser mouse, comprising a housing (2) which forms a support (2a) for the palm of the hand and is provided with at least one operable actuating element, characterised in that the housing (2) is in the form of a miniaturised car model, the front hood (5) of which has a plurality of actuating elements.

2. The computer mouse according to claim 1, characterised in that the housing (2) of the car model has a front hood (5) which is divided into at least two parts, and two button surfaces (5a, 5b) are formed by the latter, a scroll or mouse wheel (7) projecting upwards from a gap provided between the parts.

3. The computer mouse according to claim 1, characterised in that the housing (2) can be placed with the wheels (3) of the car model on a work surface (4) and on its lower side has a base (10) provided with a light hole (11), when the housing (2) is placed on the work surface (4) there being a gap (15) between the work surface and a lower surface (10a) of the base (10).

4. The computer mouse according to claim 3, characterised in that the wheels (3) of the car model can turn and can be steered by moving the computer mouse, the outer circumference of the base (10) allowing the wheels (3) to swivel out of a straight direction.

5. The computer mouse according to claim 1, characterised in that there is additionally integrated into the housing (2) at least one mass storage device (21) for storing data and at least one interface, preferably a USB connection (20) for connecting the mass storage device (21) to a computer or similar.

6. The computer mouse according to claim 5, characterised in that a USB connection (20) is disposed as an interface on the side outer circumference of the base (10).

7. The computer mouse according to claim 6, characterised in that the USB connection (20) is disposed in the rear region of the car model and of its base (10).

8. The computer mouse according to claim 1, characterised in that individual components of the car model, such as e.g. the external mirrors (9), form the operable actuating elements for additional functions.

9. The computer mouse according to claim 1, characterised in that when the mouse (1) is switched on by means of an on and off switch (12) an engine noise can be heard and/or car lights can be switched on and/or a car horn can be sounded.

10. The computer mouse according to claim 1 characterised in that a chargeable accumulator or a chargeable battery is accommodated in the housing (2), and the mouse (1) is functionally connected to a receiver without a wire or cable.

11. The computer mouse according to claim 10, characterised in that in order to charge the accumulator or the battery the housing (2) with the base (10) can be plugged into a charging station (25) that can be connected to the mains voltage or to the computer.

12. The computer mouse according to claim 10, characterised in that the housing (2) is provided with solar cells for charging the accumulator or the battery.

13. The computer mouse according to claim 1, characterised in that the car model reproduces an existing make of car, such as a Ferrari, Fiat or others.
